(19) United States
(12) Patent Application Publication
(10) Pub. No.: US 2016/0349408 A1
(43) Pub. Date: Dec. 1, 2016

(54) PREDICTION VERIFICATION USING A SELF-CALIBRATING CAMERA

(71) Applicant: International Business Machines Corporation, Armonk, NY (US)

(72) Inventor: Frank Suits, Garrison, NY (US)

(21) Appl. No.: 14/725,000

(22) Filed: May 29, 2015

(51) Int. Cl. G01W 1/10; G06T 7/20; G06T 7/00

(52) U.S. Cl. CPC G01W 1/10; G06T 7/0018; G06T 7/20; G06T 7/0044; G06T 2207/10016; G06T 2207/30241

(57) ABSTRACT

A computer processor may determine a predicted object attribute for a target object by analyzing a prediction model. The camera may capture a first image and then, after some time, a second image that both contain the target object. By comparing the first and second images, the computer processor may determine a measured object attribute for the target object. The processor may then determine whether the prediction model is accurate by comparing the measured object attribute to the predicted object attribute.

### BACKGROUND

The present disclosure relates generally to the field of image processing, and more particularly to validating a prediction model by monitoring a target object using a camera.

Models that predict real world behaviors are often validated or invalidated by comparing them to real world measurements taken using sensors. For example, a weather forecast may predict a wind speed and direction. Wind sensors that measure the wind speed may be used to validate the forecast. In response to determining that the forecast is incorrect, the weather model that generates the forecast may be updated using the real world measurements, such as the measured wind speed. The sensors must be carefully and routinely calibrated to ensure that their measurements are accurate. Inaccurate sensors may cause an inaccurate model to be validated, or may cause an accurate model to be modified based on incorrect data.

In geometric optics, distortion is a deviation from a rectilinear projection. A rectilinear projection is a projection in which straight lines in the real world remain straight in an image. Distortion is a form of optical aberration. Image distortion is often caused by the use of camera lenses, particularly lenses with high fields of view such as fisheye lenses. Although distortion can be irregular or follow many patterns, the most commonly encountered distortions are radially symmetric, or approximately so, arising from the symmetry of the photographic lens. These radial distortions are usually classified as either barrel distortions, pincushion distortions, or mustache distortions.

In barrel distortion, image magnification decreases with distance from the optical axis. The apparent effect is that of an image which has been mapped around a sphere (or barrel). Fisheye lenses, which take hemispherical views, utilize this type of distortion as a way to map an infinitely wide object plane into a finite image area. In a zoom lens, barrel distortion appears in the middle of the lens's focal length range and is worst at the wide-angle end of the range.

In pincushion distortion, image magnification increases with the distance from the optical axis. The visible effect is that lines that do not go through the center of the image are bowed inwards, towards the center of the image, like a pincushion. Mustache distortion is a mix of both barrel distortion and pincushion distortion, and is sometimes referred to as complex distortion. The center of the image appears the same as with barrel distortion, and the distortion gradually turns into pincushion distortion towards the image periphery.

### SUMMARY

Embodiments of the present invention disclose a method, computer program product, and system for validating a prediction model by monitoring a target object using a camera. A computer processor may determine a predicted object attribute for a target object by analyzing a prediction model. The camera may capture a first image and then, after some time, a second image that both contain the target object. By comparing the first and second images, the computer processor may determine a measured object attribute for the target object. The processor may then determine whether the prediction model is accurate by comparing the measured object attribute to the predicted object attribute. If the computer processor determines that the prediction model is accurate, it may validate the prediction model.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 illustrates a block diagram of an exemplary environment in which illustrative embodiments of the present disclosure may be implemented.

FIGS. 2A and 2B illustrate example images and captured by the camera of FIG. 1 that may be used to validate a weather forecast, in accordance with embodiments of the present disclosure.

FIG. 3A illustrates an example plot of stars in a night sky that may be used to calibrate a camera, in accordance with embodiments of the present disclosure.

FIG. 3B illustrates a calibrated plot after the camera has determined its orientation and applied an image transform, in accordance with embodiments of the present disclosure.

FIG. 4 is a flowchart illustrating a method for validating a weather forecast using a sky-facing camera, in accordance with embodiments of the present disclosure.

FIG. 5 illustrates a high-level block diagram of an example computer system that may be used in implementing one or more of the methods, tools, and modules, and any related functions, described herein, in accordance with embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the invention.

### DETAILED DESCRIPTION

The present disclosure relates generally to the field of image processing, and more particularly to validating a prediction model by monitoring a target object using a camera. While the present disclosure is not necessarily limited to such applications, various aspects of the disclosure may be appreciated through a discussion of various examples using this context.

In the following detailed description, embodiments of the present disclosure relating to validating a weather forecast (or weather model) are discussed in detail. While application of the present disclosure may apply to validation of other prediction models, and is not limited to validating a weather forecast, the present disclosure is shown by way of specific illustrative embodiments. It is to be understood that the present disclosure is not limited to the specific embodiments discussed.

Models that predict real world behaviors are often validated or invalidated by comparing them to real world measurements taken using sensors. For example, a weather forecast may predict a wind speed and direction. Wind sensors that measure the wind speed may be used to validate the forecast. If the forecast is incorrect, the model that generates the forecast may be updated using the real world measurements, such as the measured wind speed. The sensors must be carefully and routinely calibrated to ensure that their measurements are accurate. Inaccurate sensors may cause an inaccurate model to be validated, or may cause an accurate model to be modified based on incorrect data.

In geometric optics, distortion is a deviation from a rectilinear projection. A rectilinear projection is a projection in which straight lines in the real world remain straight in an image. Distortion is a form of optical aberration. Image distortion is often caused by the use of camera lenses, particularly lenses with high fields of view such as fisheye lenses. Although distortion can be irregular or follow many patterns, the most commonly encountered distortions are radially symmetric, or approximately so, arising from the symmetry of the photographic lens. These radial distortions are usually classified as either barrel distortions, pincushion distortions, or mustache distortions.

In barrel distortion, image magnification decreases with distance from the optical axis. The apparent effect is that of an image which has been mapped around a sphere (or barrel). Fisheye lenses, which take hemispherical views, utilize this type of distortion as a way to map an infinitely wide object plane into a finite image area. In a zoom lens, barrel distortion appears in the middle of the lens's focal length range and is worst at the wide-angle end of the range.

In pincushion distortion, image magnification increases with the distance from the optical axis. The visible effect is that lines that do not go through the center of the image are bowed inwards, towards the center of the image, like a pincushion. Mustache distortion is a mix of both barrel distortion and pincushion distortion, and is sometimes referred to as complex distortion. The center of the image appears the same as with barrel distortion, and the distortion gradually turns into pincushion distortion towards the image periphery.

Most of the data collected from weather sensors must be implicitly trusted. The sensors are assumed to be accurate and properly calibrated because there is no simple way to confirm, for example, that a sensor that detects wind direction has been carefully calibrated relative to north. In some embodiments of the present disclosure, a sky-facing camera may be used to track a target object, determine a measured object attribute for the target object, and determine whether a weather forecast was correct by comparing the measured object attribute to a predicted object attribute.

As used herein, a “prediction model” includes models that leverage statistics to predict outcomes, particularly outcomes that can be confirmed or disputed using data collected from a digital camera. For example, a weather forecast is a type of prediction model. A “target object” is any object that may be tracked using a digital camera to validate or invalidate a prediction model. For example, a weather forecast that predicts a wind velocity may be validated by tracking the movement of clouds in the sky. Accordingly, a cloud may be a target object. A target's object “image velocity” is the number of pixels per second that the target object moved in the time between two images being captured by a stationary camera. For example, a target object that moves across 100 pixels in 50 seconds has an image velocity of 2 pixels per second.

An “object attribute” is a characteristic of the target object that may be compared to a prediction model to determine whether the model is accurate. An object attribute may be determined by analysis of images or video of the target object. For example, the speed, direction, angular velocity, acceleration, or angular acceleration of a target object may all be object attributes. A “measured object attribute” is the object attribute of the target object as determined by analysis of images or video, while a “predicted object attribute” is the object attribute that the prediction model predicts the target object will have. An “image transform” includes a scalar multiplier, an equation, or a mask that can be used to convert image motion (such as image velocity) to real world motion (such as angular velocity relative to the camera). An image transform may also be used to remove distortion from images, such as barrel distortion from images captured by a camera with a fisheye lens.

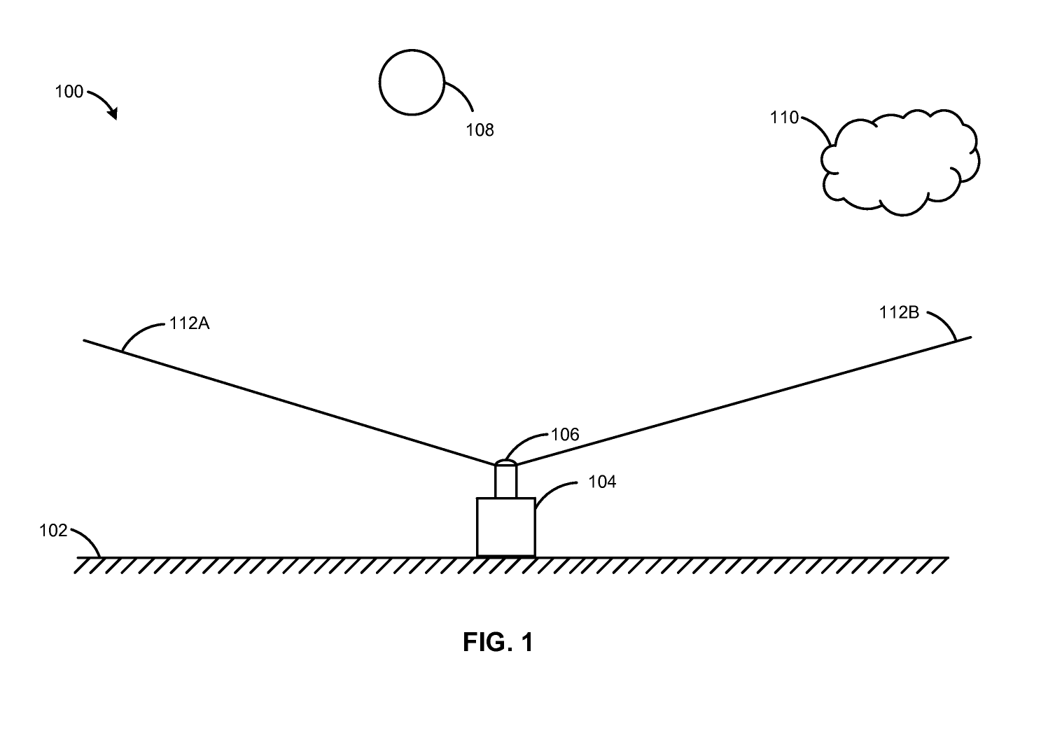

Referring now to the figures, FIG. 1 illustrates a block diagram of an exemplary environment 100 in which illustrative embodiments of the present disclosure may be implemented. The environment 100 may include a camera 104 with a lens 106 positioned proximate to the earth 102 such that the lens of the camera is facing the sky. The camera 104 has a field of view represented by lines 112A and 112B. Situated within the field of view are the Sun 108 and a cloud 110. The cloud 110 is the target object that may be tracked by the camera 104 to validate a weather forecast.

The lens 106 may be any type of camera lens that allows the camera 104 to capture an image of the target object, in this case the cloud 110. For example, the lens 106 may be an infrared lens, an ultraviolet lens, or a standard rectilinear projection lens. In some embodiments, a fisheye lens may be used because fisheye lenses often have fields of view approaching, and sometimes surpassing, 180 degrees. This may be particularly advantageous for validating weather forecasts because it allows for tracking a cloud 110 or other target object for the longest period of time (e.g., from when the cloud appears over the horizon to when the cloud disappears back over the horizon).

In some embodiments, the camera 104 may be self-calibrating so that the orientation of the camera and the camera's distortion can be determined. Common types of distortion include barrel distortion, pincushion distortion, and mustache distortion. Any method of calibrating the camera 104 to determine its orientation and to correct for distortions caused by the lens 106 may be used consistent with the present disclosure.

For example, in some embodiments the camera may track the motion of a celestial body, such as the Sun, as it moves across the camera's field of view. Because the angular position of the Sun with respect to a given point on Earth (e.g., at a given latitude and longitude) and at a given time is well known, the orientation of the camera can be determined by comparing the known location of the Sun to the location of the Sun in the image. A GPS unit may be coupled to the camera to ensure that the camera's geographic position on earth (latitude and longitude) is known to a high degree of accuracy. This ensures that the relative angular position of the sun can be accurately measured.

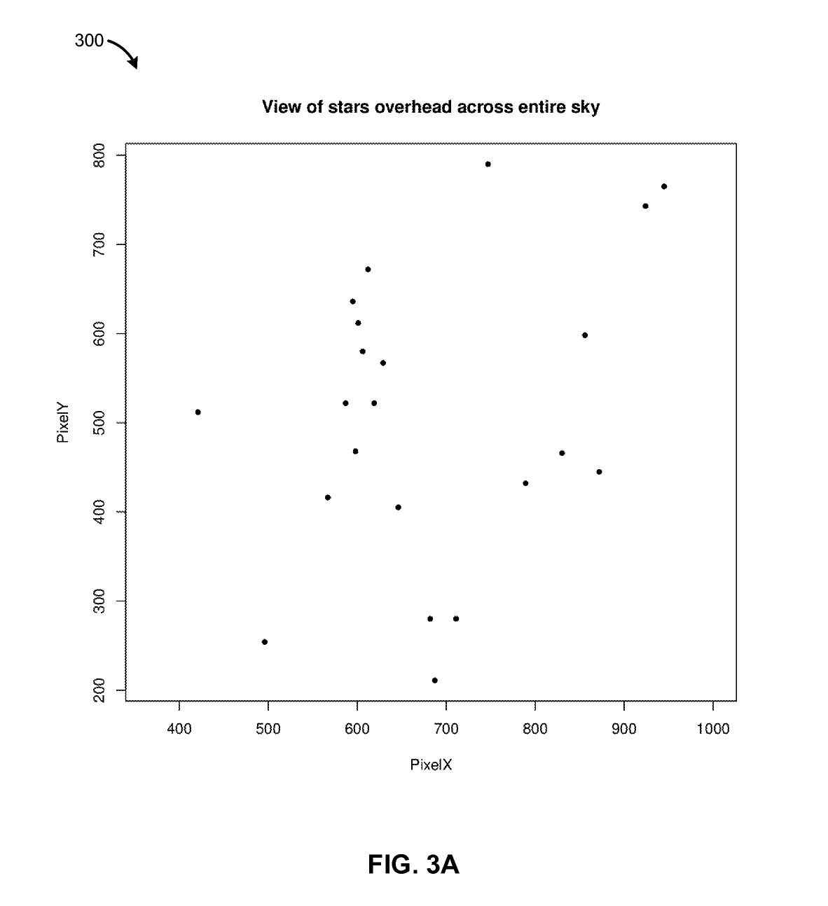

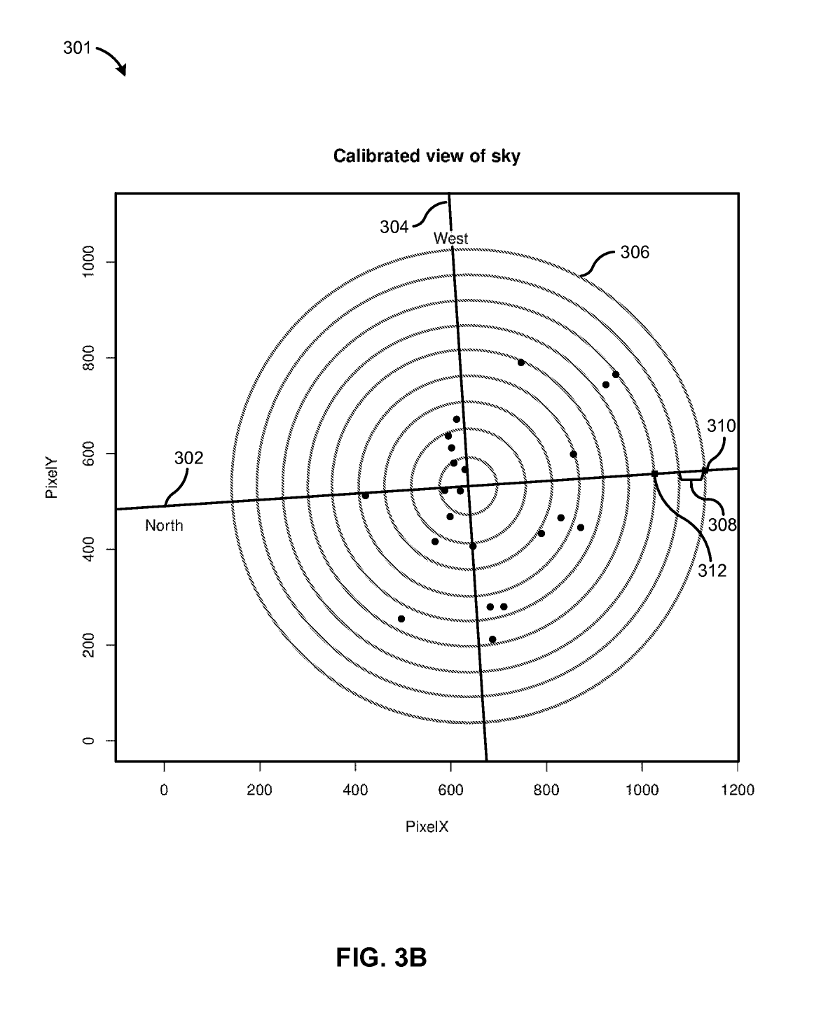

In some embodiments, a picture of the night sky showing a plurality of stars may be compared to a star chart (or star map) to calibrate the camera. This calibration method is discussed more thoroughly in reference to FIGS. 3A and 3B.

In some embodiments, the calibration of the camera can also determine distortions in the image caused by, e.g., the lens. The above mentioned calibration methods can also be used to determine the distortion effects of the lens on the captured images. For example, fisheye lenses frequently suffer from barrel distortion, where the image is compressed around the edges and stretched in the center as if the image was mapped around a sphere or barrel. The distortion may significantly change the measured object attributes, such as angular velocity, of objects tracked with a camera. By comparing, e.g., the known location of stars in the sky with where they are located in the image, the distortion effects of the lens can be determined and compensated for during the image processing.

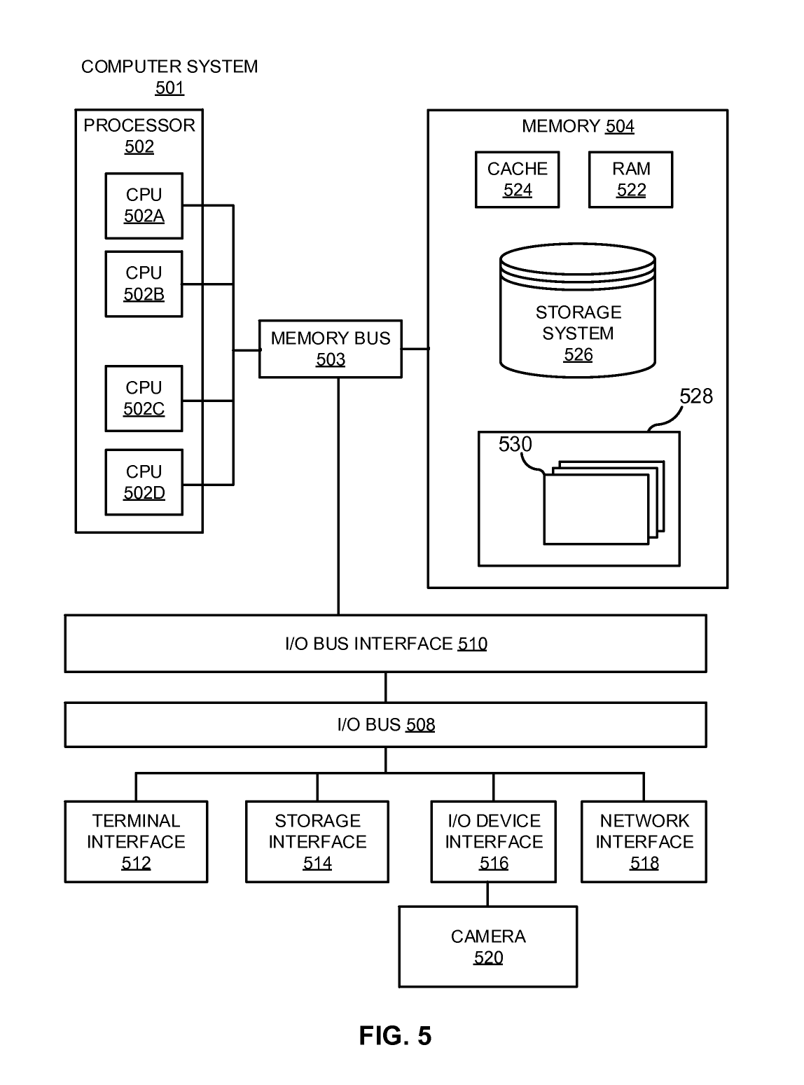

In some embodiments, the camera 104 may include a computer system (like the one discussed in reference to FIG. 5) to perform image processing on the captured images to calibrate the camera (e.g., to determine orientation and to remove distortion) and/or to validate a weather forecast. In some embodiments, the camera 104 may be communicatively coupled to the computer system that is used to calibrate the camera and validate the weather forecast. The camera 104 may include a GPS unit to accurately determine the camera's latitude and longitude.

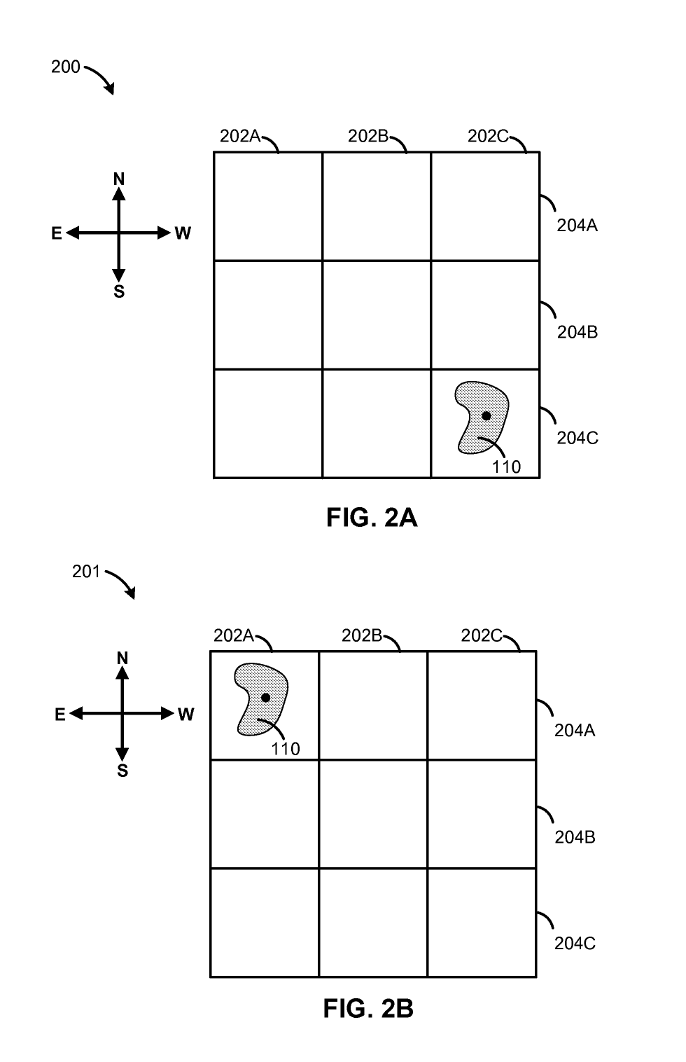

FIGS. 2A and 2B illustrate example images 200 and 201 captured by the camera 104 of FIG. 1 that may be used to validate a weather forecast, in accordance with embodiments of the present disclosure. Both FIGS. 2A and 2B include the cloud 110, and the second image 201 may have been captured subsequent to the first image 200. For illustrative purposes, the area captured by the camera 104 and depicted in FIGS. 2A and 2B has been divided into nine regions defined by three rows 204A-C and three columns 202A-C. Each region represents a 50 by 50 pixel section of the images 200 and 201. It should be noted that the compass directions indicated for both images, particularly the east and west directions, appear reversed because the camera is facing towards the sky instead of towards the ground.

FIG. 2A shows the first image 200 taken by the camera 104. In this image 200, the cloud 110 can be seen in the bottom right (south west) region, in the third row 204C and the third column 202C. FIG. 2B shows the second image 201 taken by the camera 104. The second image 201 may have been taken after the first image 200, for example 25 seconds later. In the second image 201, the cloud 110 is in the top left (north east) region, in the first row 204A and the first column 202A.

From these two images 200 and 201, the camera 104 can calculate the angular velocity of the cloud 110 in order to determine whether the weather forecast is correct. First, the camera 104 can calculate the image velocity of the cloud 110. The image velocity is the number of pixels per second that the cloud moved in the time between when the first image 200 was captured and when the second image 201 was captured. Because the image is two-dimensional, the image velocity may be calculated as having two directional components, such as a north-south component and an east-west component. In this example, the cloud 110 moved two regions north and two regions to the east, and the images were taken 25 seconds apart. Because each region is 50 pixels by 50 pixels, this corresponds to an image velocity of 4 pixels per second northward and 4 pixels per second eastward.

In some embodiments, it may be beneficial to calculate the image velocity as a single vector with a magnitude and direction because, e.g., weather forecasts often indicate wind speed as a magnitude and directions (e.g., 5 mph NNW). In these cases, vector physics may be used to combine the two component image velocities. For example, the magnitude of the image velocity |V| in this example may be calculated using the equation:

|N|=\sqrt{V_{NS}²+V_{EW}²}

where V_{NS} is the magnitude of the north-south velocity component (4 pixels per second) and V_{EW} is the magnitude of the east-west velocity component (4 pixels per second). In this example, the magnitude of the image velocity vector is approximately 5.66 pixels per second.

The compass direction (bearing) θ of the vector may be calculated using the equation:

$$Θ = 90 - arctan ( \frac{{V}_{NS}}{{V}_{EW}} ) + n ⋆ 180$$

where V_{NS} is positive if the cloud is heading north and negative if it is traveling south, V_{EW} is positive if the cloud is heading east and negative if it is heading west, and n is 1 if V_{EW} is negative (west) and 0 if V_{EW} is positive (east). Using the example previously discussed (4 pixels per second north and 4 pixels per second east), the compass direction (bearing) θ is 45 degrees.

After determining the image velocity for the cloud 110, the camera 104 may apply an image transform to the image velocity to determine the cloud's angular velocity relative to the camera. An image transform may include a scalar multiplier, an equation, or a mask that can be used to convert image motion (such as image velocity) to real world motion (such as angular velocity relative to the camera). The image transform can be determined during the camera calibration process.

In some embodiments, the image transform may be a scalar multiplier that can convert pixel to angles. This may be useful when the captured image has very little to no distortion. For example, the images 200 and 201 captured by the camera 104 may have little to no distortion, and a change in position of 10 pixels in the image may represent a 1 degree change in angular position of the cloud 110 relative to the camera. Accordingly, the image transform for this camera 104 may be a scalar ( 1/10) that can be multiplied by the image velocity to determine the real world angular velocity. Because the cloud's image velocity was 4 pixels per second (or 240 pixels per minute) north and 4 pixels per second (240 pixels per minute) east, the measured angular velocity of the cloud relative to the camera may be 0.4 degrees per second (24 degrees per minute) north and 0.4 degrees per second (24 degrees per minute) east.

In some embodiments, it may be beneficial to calculate the angular velocity as a single scalar with a magnitude. In these cases, vector physics may be used to combine the two component angular velocities. For example, the magnitude of the angular velocity |ω| in this example may be calculated using the equation:

|ω|=\sqrt{ω_{NS}²+φ_{EW}²}

where φ_{NS} is the magnitude of the north-south angular velocity component (24 degrees per minute) and ω_{EW} is the magnitude of the east-west angular velocity component (24 degrees per minute). In this example, the magnitude of the angular velocity vector is approximately 34 degrees per minute. The direction that the clouds are traveling can be calculated as discussed above using the image velocity direction equation.

In some embodiments, the image transform may be a considerably more complicated formula that considers not only the number of pixels that a target object (e.g., cloud) moved between images, but where in the two images the target object was. This may be necessary to remove the effects of the distortion from the calculation. For example, images taken with a fisheye camera are vulnerable to barrel distortion, which is strongest around the edge of the image. Accordingly, an image taken with a fisheye lens may have a 10 pixels per degree angle correspondence in the middle of the image, but a 2 pixel per degree angle correspondence at the edges.

In some embodiments, instead of removing the distortions from the images when the image velocity is converted into real world velocity, the image may be mapped to a rectilinear (or any other) projection. The rectilinear image may have the distortions from the fisheye captured image removed. The image velocity may then be calculated from the rectilinear projection, instead of from the original fisheye image.

In some embodiments, radial distortion such as barrel distortion, pincushion distortion, and mustache distortion, which is primarily dominated by low order radial components, can be corrected using Brown's distortion model, also known as the Brown-Conrady distortion model. The Brown-Conrady distortion model corrects both for radial distortion and for tangential distortion caused by physical elements in a lens not being perfectly aligned. The latter is also known as decentering distortion.

After the angular velocity and direction of the cloud 110 relative to the camera 104 have been calculated, it can be compared to the weather forecast to determine whether the forecast is correct. For some weather forecasts, the predicted angular velocity of the clouds may be explicitly stated. For other weather forecasts, the predicted angular velocity may have to be calculated. For example, some weather forecasts may indicate the predicted cloud height and the predicted wind velocity (speed and direction) at the altitude of the clouds. The predicted angular velocity can then be calculated by dividing the predicted speed by the predicted cloud height. The angular velocity can then be converted from radians per second to degrees per second as necessary.

The predicted angular velocity may then be compared to the measured angular velocity, and the predicted direction of travel (wind velocity direction) can be compared to the measured cloud direction. If the measured angular velocity and measured cloud direction are within their respective thresholds of their corresponding predicted values, the weather forecast may be validated as correct. If the measured angular velocity and/or measured cloud direction are not within their respective thresholds of their corresponding predicted values, the prediction verification module may determine that the weather forecast is incorrect.

In some embodiments, the angular velocity threshold and the cloud direction threshold may be set by a user. In other embodiments, the angular velocity threshold and the cloud direction threshold may be set by the prediction verification module according to the historical accuracy of the weather forecast. In some embodiments, the thresholds may correspond to the resolution of the camera. A camera with a higher resolution may be able to make finer measurements. Accordingly, a high resolution camera may be able to detect smaller deviations in cloud velocity and direction, and therefore be more accurate.

FIG. 3A illustrates an example plot 300 of stars in a night sky that may be used to calibrate a camera, in accordance with embodiments of the present disclosure. The plot 300 corresponds to a rectilinear projection of a section of an image taken with a camera using a fisheye lens. The plot 300 includes a plurality of stars in the night sky and plots their pixel locations (both in the x-direction and y-direction) within the captured image. The plot 300 may be used to calibrate a camera, e.g., to determine its orientation and its distortion.

A camera facing the sky may capture an image at night that includes a plurality of stars. Using known image processing techniques, the pixel location of each of the stars may be determined. For example, in some embodiments, such as where no other objects are present in the image, the stars may be simply identified and located by the magnitude of the brightness of a pixel. For example, all pixels with a brightness over a threshold may be assumed to be a star and included in the plot 300. In some embodiments, the brightness of a pixel, or group of pixels, relative to neighboring pixels may be used instead of the magnitude of the brightness. This may be particularly useful when the image is not uniformly dark, such as when light pollution from a city brightens regions of the image. In some embodiments, a filter may be applied to the image to remove objects that may be confused with stars, such as lights on top of radio towers or from airplanes.

After the stars have been plotted, the locations of the stars may be compared to a star map or star chart to calibrate the camera. The star chart used should take into account the geographic coordinates of the camera, such as its latitude and longitude. By comparing the plot 300 to the star chart, the orientation of the camera can be determined. Parallax issues are avoided because the stars are sufficiently far away from the camera.

For example, the camera (or a computer system) can compare the positions of the stars in the plot (relative to other stars) with the positions of the stars in the star chart (relative to other stars). The camera may then determine the best fit to overlap the stars on the plot 300 with the stars in the star chart. Finding the best fit may also involve determining which stars are in the plot 300. Once the best fit is found, the orientation of the camera can be determined by comparing the orientation of the stars in the plot to their known orientation relative to the camera, using the camera's geographic coordinates.

In some embodiments, the plot 300 may also be used to generate an image transform for the camera. After the orientation of the camera is determined by comparing the plot 300 to a star chart, and the camera has determined which stars are visible in the plot, an image transform may be generated. This may be done by comparing the pixel location of individual stars in the plot to the star's well-known angular positions relative to the camera's location. For example, the north vector in the plot 300 may be determined as previously discussed. An individual star with a known angular position relative to the north vector (i.e., the star with a known azimuth and altitude) may be chosen from the plot. The camera may then compare the chosen star's azimuth and altitude to its pixel distance from the north vector to determine a pixel-to-angle correspondence for the plot. This may be done for each star in the plot so that the image transform accounts for any lens distortion present.

FIG. 3B illustrates a calibrated plot 301 after the camera has determined its orientation and applied an image transform, in accordance with embodiments of the present disclosure. The plot 301 is of the same image that was used to create the plot 300 of FIG. 3A. The plot 301 shows a plurality of stars, a line 302 representing the North-South direction, and a line 304 representing the East-West direction. As can be seen in FIG. 3B, north is generally to the left of the plot 301, and west is generally towards the top of the plot. The zenith is located where the North-South line 302 and East-West line 304 cross.

The plot 301 also includes a grid of nine circles 306. The circles 306, along with the lines 302 and 304, break the plot into 18 sections as you travel along the North-South line 302 or the East-West line 304, such as the section 308. Because the plot was generated from an image taken with a fisheye lens having more than a 180 degree field of view, each section represents a change of roughly 10 degrees. For example, if a cloud traveling in a due north direction along the North-South line 302 were to start at a first position 310 and, after 1 minute, is at a second point 312, it will have crossed two sections. Because each section corresponds to a 10 degree change in position, the cloud will have traveled 20 degrees in 1 minutes, corresponding to an angular velocity of 20 degrees per minute. In some embodiments, the sections would have non-uniform widths to account for the distortion of the image.

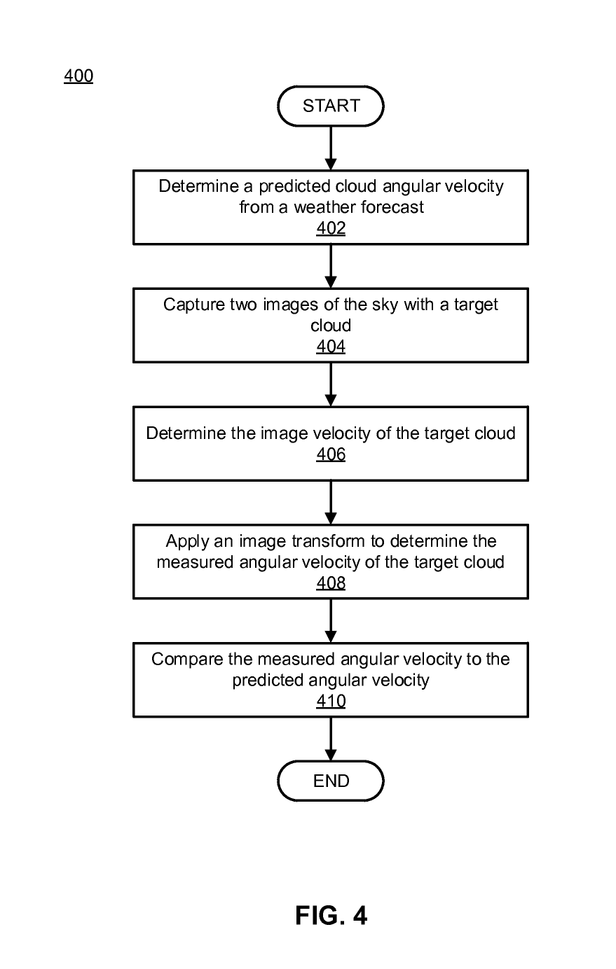

FIG. 4 is a flowchart illustrating a method 400 for validating a weather forecast using a sky-facing camera, in accordance with embodiments of the present disclosure. In some embodiments, the method 400 may be performed by a prediction verification module in a digital camera. In some embodiments, the method 400 may be performed by a combination of a camera and a prediction verification module in a communicatively coupled computer system, such as the one discussed in reference to FIG. 5. The computer system may be a remote system or may be connected to the camera through a wired connection. The method 400 may begin at operation 402, wherein a predicted cloud angular velocity may be determined from a weather forecast.

The weather forecast may include a predicted height of the clouds, and a predicted wind velocity at that height. From this information, a predicted angular velocity of the clouds may be calculated relative to the camera. In some embodiments, the forecast may directly include a predicted angular velocity of the clouds for a given viewpoint. In some embodiments, the weather forecast may be considerably more complex. For example, the weather forecast may predict that the clouds velocity will change as it approaches the camera's position, so the predicted angular velocity will have to account for the cloud's location.

As another example, the weather forecast may involve forecasting a severe weather event, such as a tropical storm. The tropical storm may be predicted to increase or decrease its speed as it passes over certain locations, such as land, or to change direction. The tropical storm may also have multiple velocities associated with it, such as the velocity of its rotation and its translational velocity across the ground. In these embodiments, determining the predicted angular velocity may require more complex analysis, such as finite element analysis of the weather forecast. The above described methods for determining a predicted object attribute from a weather forecast are shown for illustrative purposes only. Other methods to determine a predicted object attribute, such as predicted velocities and accelerations, from a weather forecast or model will be recognized by a person of ordinary skill in the art, and all such methods that are not otherwise incompatible with this disclosure are contemplated.

After determining the predicted angular velocity of the clouds per operation 402, a sky-facing camera may capture two images of the sky at operation 404. The second image may be captured after the first image. Both the first and the second images may include one or more clouds, including a target cloud that appears in both images. Known image processing techniques for isolating the target cloud in both images will be understood by a person of ordinary skill in the art. Any such image processing technique may be used to practice the method 400. After capturing the two images per operation 404, the image velocity of the target cloud may be determined at operation 406.

The image velocity is the number of pixels per second that the cloud moved in the time between when the first image was captured and when the second image was captured. Because the image is two-dimensional, the image velocity may be calculated as having two directional components, such as a north-south component and an east-west component. For example, if a selected point on the target cloud moved 250 pixels between the first and second images, which were taken 25 seconds apart, the image velocity for the cloud may be 10 pixels per second. Any point or group of points on the target cloud may be tracked across images. For example, in some embodiments, an edge of the cloud may be tracked across images. In other embodiments, the geometric center of the cloud may be tracked. After determining the image velocity of the target cloud per operation 406, an image transform may be applied to the image velocity to determine the measured angular velocity of the target cloud at operation 408.

In embodiments, once the camera's distortion is known, an image transform may be generated. The image transform may be used by a processor to convert pixel information to real world location information. For example, a camera with a perfect fisheye lens may have a 180 horizontal degree field of view, and a horizontal resolution of 360 pixels, with no distortion. The generated image transform in this case would indicate that every 2 pixels of translation correspond to a 1 degree real world translation in the position of the target cloud with respect to the camera. Using the example discussed above where the cloud has an image velocity of 10 pixels per second, the measured angular velocity for the cloud may be determined to be 5 degrees per second relative to the camera.

After the measured angular velocity of the target cloud is determined at operation 408, the prediction verification module may compare the measured angular velocity of the target cloud to the predicted angular velocity at operation 410. If the measured angular velocity and measured cloud direction are within their respective thresholds of their corresponding predicted values, the weather forecast may be validated as correct. If the measured angular velocity and/or measured cloud direction are not within their respective thresholds of their corresponding predicted values, the prediction verification module may determine that the weather forecast is incorrect.

In some embodiments, the angular velocity threshold and the cloud direction threshold may be set by a user. In other embodiments, the angular velocity threshold and the cloud direction threshold may be set by the prediction verification module according to the historical accuracy of the weather forecast. In some embodiments, the thresholds may correspond to the resolution of the camera. A camera with a higher resolution may be able to make finer measurements. Accordingly, a high resolution camera may be able to detect smaller deviations in cloud velocity and direction, and therefore be more accurate.

In some embodiments, if the measured angular velocity is not within a threshold of the predicted angular velocity, the weather forecast may be updated. For example, if the weather forecast included a predicted wind velocity and a predicted cloud height, one or both may be changed to conform to the measured angular velocity. In some embodiments, which component of the weather forecast is changed may depend on what other information the weather forecast relies on for verification. For example, if the weather forecast also has wind velocity sensors that indicate that the predicted wind velocity is accurate, but does not have any sensors to measure cloud height, the weather forecast may update the predicted cloud height. After the prediction verification module determines whether the weather forecast is correct per operation 410, the method 400 may end.

Referring now to FIG. 5, shown is a high-level block diagram of an example computer system (e.g. a receiver) 501 that may be used in implementing one or more of the methods, tools, and modules, and any related functions, described herein (e.g., using one or more processor circuits or computer processors of the computer), in accordance with embodiments of the present disclosure. The computer system 501 may be internal to the camera, or it may be a separate device that is communicatively coupled to the camera. In some embodiments, the major components of the computer system 501 may comprise one or more CPUs 502, a memory subsystem 504, a terminal interface 512, a storage interface 514, an I/O (Input/Output) device interface 516, and a network interface 518, all of which may be communicatively coupled, directly or indirectly, for inter-component communication via a memory bus 503, an I/O bus 508, and an I/O bus interface unit 510. A camera 520 may be connected to the computer system 501 via the I/O device interface 516. The computer system 501 may also include a clock, or other means, for determining the elapsed time.

The computer system 501 may contain one or more general-purpose programmable central processing units (CPUs) 502A, 502B, 502C, and 502D, herein generically referred to as the CPU 502. In some embodiments, the computer system 501 may contain multiple processors typical of a relatively large system; however, in other embodiments the computer system 501 may alternatively be a single CPU system. Each CPU 502 may execute instructions stored in the memory subsystem 504 and may include one or more levels of on-board cache.

System memory 504 may include computer system readable media in the form of volatile memory, such as random access memory (RAM) 522 or cache memory 524. Computer system 501 may further include other removable/non-removable, volatile/non-volatile computer system storage media. By way of example only, storage system 526 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 504 can include flash memory, e.g., a flash memory stick drive or a flash drive. Memory devices can be connected to memory bus 503 by one or more data media interfaces. The memory 504 may include at least one program product having a set (e.g., at least one) of program modules that are configured to carry out the functions of various embodiments.

One or more programs/utilities 528, each having at least one set of program modules 530 may be stored in memory 504. The programs/utilities 528 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Program modules 530 generally perform the functions or methodologies of various embodiments.

For example, in an embodiment of the present disclosure, the program modules 530 may include an image analysis module, a prediction verification module, and a camera calibration module. The image analysis module may include instructions to import images or video from the camera 520, to track a target object (e.g., a cloud), and to determine one or more target object attributes, such as the angular velocity of the target object with respect to the camera. The prediction verification module may include instructions to determine, from a prediction model (e.g., a weather forecast), predicted object attributes (e.g., the predicted angular velocity of a cloud). After analyzing the prediction model to determine one or more predicted object attribute, the prediction verification module may further include instructions to compare the predicted object attributes to the determined target object attributes, and may determine whether the prediction was accurate. The camera calibration module may include instructions to import images or videos from the camera 520, determine the location of one or more celestial bodies (e.g., stars) in the image(s), compare the location of the celestial bodies to their known locations (using, e.g., star maps), and determine the orientation of the camera. The camera calibration module may further include instructions to determine the distortion effects of the camera's 520 lens on the location of the celestial bodies in the image so that the image analysis module may accurately determine the object attributes for the target object.

Although the memory bus 503 is shown in FIG. 5 as a single bus structure providing a direct communication path among the CPUs 502, the memory subsystem 504, and the I/O bus interface 510, the memory bus 503 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 510 and the I/O bus 508 are shown as single respective units, the computer system 501 may, in some embodiments, contain multiple I/O bus interface units 510, multiple I/O buses 508, or both. Further, while multiple I/O interface units are shown, which separate the I/O bus 508 from various communications paths running to the various I/O devices, in other embodiments some or all of the I/O devices may be connected directly to one or more system I/O buses.

In some embodiments, the computer system 501 may be a multi-user mainframe computer system, a single-user system, or a server computer or similar device that has little or no direct user interface, but receives requests from other computer systems (clients). Further, in some embodiments, the computer system 501 may be implemented as a desktop computer, portable computer, laptop or notebook computer, tablet computer, pocket computer, telephone, smart phone, network switches or routers, or any other appropriate type of electronic device.

It is noted that FIG. 5 is intended to depict the representative major components of an exemplary computer system 501. In some embodiments, however, individual components may have greater or lesser complexity than as represented in FIG. 5, components other than or in addition to those shown in FIG. 5 may be present, and the number, type, and configuration of such components may vary.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of exemplary embodiments of the various embodiments, reference was made to the accompanying drawings (where like numbers represent like elements), which form a part hereof, and in which is shown by way of illustration specific exemplary embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. But, the various embodiments may be practiced without these specific details. In other instances, well-known circuits, structures, and techniques have not been shown in detail in order not to obscure embodiments.

Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application, or technical improvement over technologies found in the marketplace, or to enable others of ordinary skill in the art to understand the embodiments disclosed herein.

Although the present invention has been described in terms of specific embodiments, it is anticipated that alterations and modification thereof will become apparent to the skilled in the art. Therefore, it is intended that the following claims be interpreted as covering all such alterations and modifications as fall within the true spirit and scope of the invention.

What is claimed is:

1. A computer implemented method for validating a prediction model, the method comprising:
determining a predicted object attribute for a target object by analyzing a prediction model;
capturing, by a camera, a first image and a second image, the second image being captured subsequent to the first image being captured, wherein the first and second images contain the target object;
determining, by a processor, a measured object attribute for the target object by comparing the first and second images;
determining, by the processor, whether the prediction model is correct by comparing the measured object attribute to the predicted object attribute; and
validating, by the processor and in response to determining that the prediction model is correct, the prediction model.

2. The method of claim 1, wherein the target object is a cloud, the object attribute is an angular velocity, and the prediction model is a weather forecast.

3. The method of claim 2, wherein the determining a predicted object attribute comprises:
determining, from the weather forecast, a predicted cloud height;
determining, from the weather forecast, a predicted wind velocity at the predicted cloud height; and
calculating a predicted angular velocity for the cloud using the predicted wind velocity and the predicted cloud height.

4. The method of claim 1, the method further comprising:
updating, in response to determining that the prediction model is incorrect, the prediction model using the measured object attribute.

5. The method of claim 1, wherein the determining a measured object attribute for the target object comprises:
determining a first pixel location for the target object, the first pixel location corresponding to the first image;
determining a second pixel location for the target object, the second pixel location corresponding to the second image;
determining an image velocity by comparing the first pixel location and the second pixel location; and
determining the measured object attribute by applying an image transform to the image velocity.

6. The method of claim 1, the method further comprising calibrating the camera by:
capturing a third image, the third image containing two or more celestial bodies;
determining a pixel location for each of the two or more celestial bodies;
determining a known location for the two or more celestial bodies; and
calibrating the camera by comparing the pixel locations for the two or more celestial bodies to the known location for the two or more celestial bodies.

7. A system for validating a prediction model comprising:
a memory to store an image analysis module and a prediction verification module; and
a processor configured to:
run the image analysis module, wherein the image analysis module is configured to:
import, from a camera, a first image and a second image, the first and second images containing a target object; and
determine a measured object attribute for the target object by comparing the first and second images;
run the prediction verification module, wherein the prediction verification module is configured to:
determine, from a prediction model, a predicted object attribute for the target object; and
determine, in response to determining a predicted object attribute for the target object, whether the prediction model is accurate by comparing the predicted object attribute to the measured object attribute.

8. The system of claim 7, the system further comprising a digital camera.

9. The system of claim 8, wherein the digital camera includes a GPS module.

10. The system of claim 8, wherein the memory further stores a camera calibration module, and wherein the processor is further configured to run the camera calibration module.

11. The system of claim 10, wherein the camera calibration module is configured to:
capture a third image, the third image containing two or more celestial bodies;
determine a pixel location for each of the two or more celestial bodies;
determine a known location for the two or more celestial bodies; and
determine an orientation of the camera by comparing the pixel locations for the two or more celestial bodies to the known location of the two or more celestial bodies.

12. The system of claim 7, wherein the target object is a cloud, the prediction model is a weather model, and the object attribute is an angular velocity.

13. A computer program product for validating a prediction model, the computer program product comprising a computer readable storage medium having program instructions embodied therewith, wherein the computer readable storage medium is not a transitory signal per se, the program instruction executable by a processor to cause the processor to perform a method comprising:
determining a predicted object attribute for a target object by analyzing a prediction model;
capturing, by a camera, a first image and a second image, the second image being captured subsequent to the first image being captured, wherein the first and second images contain the target object;
determining a measured object attribute for the target object by comparing the first and second images;
determining whether the prediction model is correct by comparing the measured object attribute to the predicted object attribute; and
validating, in response to determining that the prediction model is correct, the prediction model.

14. The computer program product of claim 13, wherein the target object is a cloud, the object attribute is an angular velocity, and the prediction model is a weather forecast.

15. The computer program product of claim 14, wherein the determining a predicted object attribute comprises:
determining, from the weather forecast, a predicted cloud height;
determining, from the weather forecast, a predicted wind velocity at the predicted cloud height; and
calculating a predicted angular velocity for the cloud using the predicted wind velocity and the predicted cloud height.

16. The computer program product of claim 13, the method performed by the processor further comprising:
updating, in response to determining that the prediction model is incorrect, the prediction model using the measured object attribute.

17. The computer program product of claim 13, wherein the determining a measured object attribute for the target object comprises:
determining a first pixel location for the target object, the first pixel location corresponding to the first image;
determining a second pixel location for the target object, the second pixel location corresponding to the second image;
determining an image velocity by comparing the first pixel location and the second pixel location; and
determining the measured object attribute by applying an image transform to the image velocity.

18. The computer program product of claim 13, the method performed by the processor further comprising calibrating the camera by:
capturing a third image, the third image containing two or more celestial bodies;
determining a pixel location for each of the two or more celestial bodies;
determining a known location for the two or more celestial bodies; and
calibrating the camera by comparing the pixel locations for the two or more celestial bodies to the known location for the two or more celestial bodies.
